(19) United States
(12) Patent Application Publication
(10) Pub. No.: US 2018/0254022 A1
(43) Pub. Date: Sep. 6, 2018

(54) ADJUSTING DISPLAYS ON USER MONITORS AND GUIDING USERS' ATTENTION

(71) Applicant: Elbit Systems Ltd., Haifa (IL)

(72) Inventor: Avner SHAHAL, Haifa (IL)

(73) Assignee: Elbit Systems Ltd., Haifa (IL)

(21) Appl. No.: 15/759,229

(22) PCT Filed: Sep. 7, 2016
(86) PCT No.: PCT/IL2016/050993

§ 371 Date: Mar. 12, 2018

(30) Foreign Application Priority Data
Sep. 10, 2015 (IL) 241446

(51) Int. Cl. G09G 5/37; G06F 3/14; G06F 3/01; G01C 23/00

(52) U.S. Cl. CPC G09G 5/37; G06F 3/1423; G06F 3/013; G01C 23/005; G01C 21/36; G09G 2320/08; G09G 2340/14; G09G 2380/10; G09G 2380/12; G09G 2354/00

(57) ABSTRACT

Systems and methods are provided, for managing the attention of a user attending a display and for managing displayed information in control centers. Methods and systems may identify, from displayed data, a piece of information, locate a display position of the identified piece of information, and display the visual cue at a specified interval prior to displaying the piece of information, at a cue position on the display that has a specified spatial relation to the display position of the piece of information. Methods and systems may further quantify an attention pattern of a user, relate it to recorded reaction times of the user to the displayed data, and modify spatio-temporal parameters of the visual cues to decrease the user's reaction times according to specified requirements. Specific data may be enhanced according to user performance and various definitions.

### BACKGROUND OF THE INVENTION

### 1. Technical Field

The present invention relates to the field of user-display interaction, and more particularly, to guiding user attention during the use of the display.

### 2. Discussion of Related Art

Displays of aircrafts and of vehicles, as well as station displays of various control centers (e.g., air control centers, unmanned aircraft control centers, traffic control centers, lookout control systems, border controls, rescue systems etc.) commonly include a large amount of data. The clutter of these displays presents a significant challenge to users such as drivers or pilots.

Posner et al. 1980 (J. of Experimental Psychology: General, vol. 109, 2, pp: 160-174), which is incorporated herein by reference in its entirety, discusses the relation of attention to the detection of signals and shows that detection latencies are reduced when subjects receive a cue that indicates where in the visual field the signal will occur.

Weiquan, Lu 2013 (National university of Singapore, Thesis), which is incorporated herein by reference in its entirety, teaches improving visual search performance in augmented reality environments using a subtle cueing approach, and compares explicit cueing with subtle cueing as ways to draw attention of an observer.

### SUMMARY OF THE INVENTION

The following is a simplified summary providing an initial understanding of the invention. The summary does not necessarily identify key elements nor limits the scope of the invention, but merely serves as an introduction to the following description.

One aspect of the present invention provides a method comprising identifying, from display-relevant data, a piece of information, locating, on a respective display, a display position of the identified piece of information, and displaying the visual cue at a specified interval prior to displaying the piece of information, at a cue position on the display that has a specified spatial relation to the display position of the piece of information.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1 and 2 are high level schematic illustrations of a cueing paradigm, according to some embodiments of the invention.

FIG. 3 is a high level schematic block diagram of a cueing system, according to some embodiments of the invention.

FIGS. 4A and 4B examples of clutter in control center displays, according to some embodiments of the invention.

FIG. 5 is a high level schematic block diagram of a system for improving information flow through control centers, according to some embodiments of the invention.

FIG. 6 is a high level schematic illustration of selection of displayed information, according to some embodiments of the invention.

FIG. 7 is a high level schematic flowchart illustrating a method, according to some embodiments of the invention.

### DETAILED DESCRIPTION OF THE INVENTION

Prior to the detailed description being set forth, it may be helpful to set forth definitions of certain terms that will be used hereinafter.

The term “display” as used in this application refers to any device for at least partly visual representation of data to a user.

The term “display-relevant data” as used in this application refers to the overall assembly of data elements which may be presented on a display, including various data types, various data values, various alerts etc.

The term “piece of information” as used in this application refers to specific data items, data points or alerts, prior to their presentation on the display.

The term “display position” as used in this application refers to a designated location on the display in which the piece of information is to be displayed. No data or any data may be displayed at the display position prior to the display of the piece of information, including a similar piece of information.

The term “stimulus” as used in this application refers to an actual display of the piece of information.

The term “cue” as used in this application refers to a graphical element that does not convey the information content of the stimulus, but relates geometrically to the display position of the stimulus.

The term “cue position” as used in this application refers to a location of the displayed cue on the display or at its margins.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways. Also, it is to be understood that the phraseology and terminology employed herein is for the purpose of description and should not be regarded as limiting.

Systems and methods are provided, for managing the attention of a user attending a display and for managing displayed information in control centers. Methods and systems may identify, from displayed data, a piece of information, locate a display position of the identified piece of information, and display the visual cue at a specified interval prior to displaying the piece of information, at a cue position on the display that has a specified spatial relation to the display position of the piece of information. Methods and systems may further quantify an attention pattern of a user, relate it to recorded reaction times of the user to the displayed data, and modify spatio-temporal parameters of the visual cues to decrease the user's reaction times according to specified requirements. The recorded information, associated with identified users, may be used as a baseline for future user-system interaction. Methods and systems may select relevant data from display-relevant data, the relevance thereof determined according to user definitions, mode definitions and/or mission definitions, display the relevant data and monitor user reactions thereto, and enhance specific data from the relevant data according to the monitored user reactions with respect to the user definitions, mode definitions and/or mission definitions. Cueing patterns may be personalized and adjusted to information priorities and user performance.

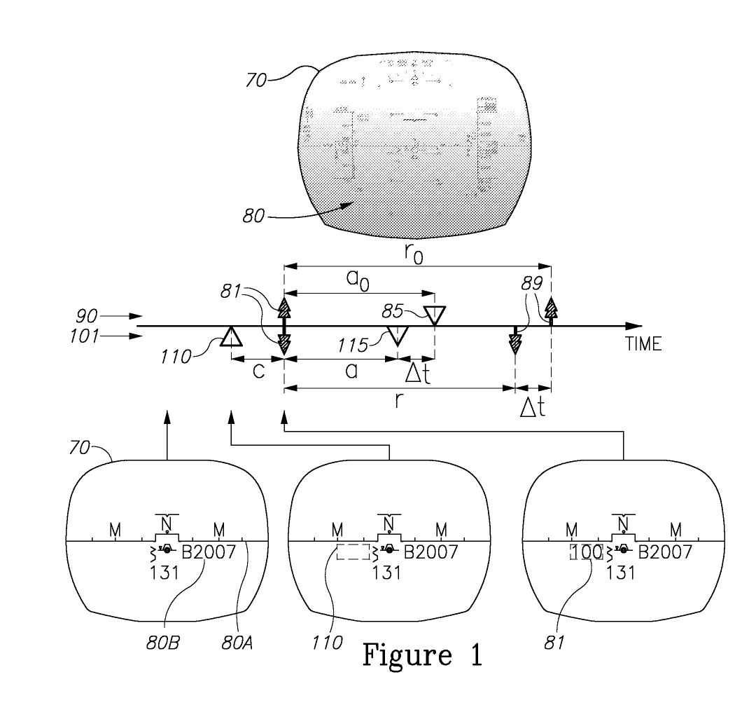

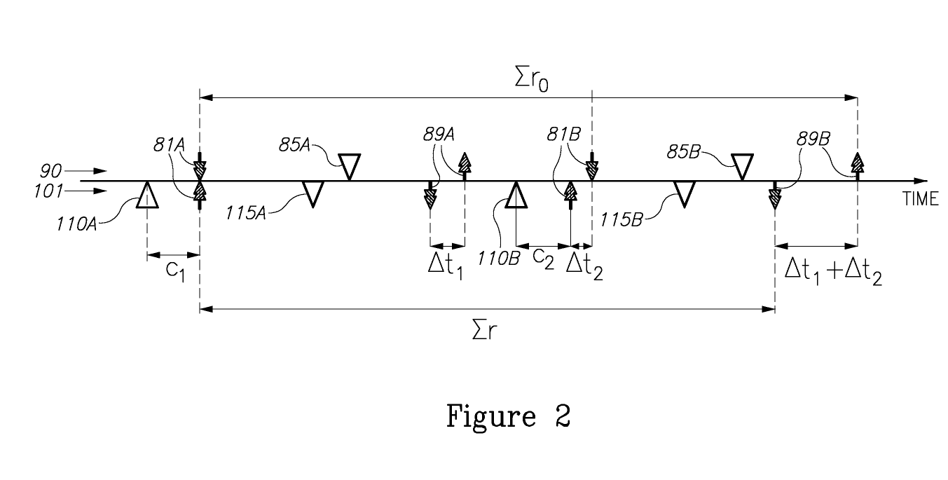

FIGS. 1 and 2 are high level schematic illustrations of a cueing paradigm 101, according to some embodiments of the invention. The top of FIG. 1 exemplifies current aircraft displays 70 with a large amount of display-relevant data 80. The middle of FIG. 1 schematically illustrate a time line with prior art stimulation paradigm 90 including a stimulus 81 (e.g., display or modification of an information piece or a data item of display-relevant data 80), an attendance 85 of a display user to stimulus 81 (manifested e.g., in a correlated eye movement) and a resulting action 89 of the user. The time between stimulus presentation 81 and attendance 85 is denoted by a₀ (time to attention reorientation) and the overall time between stimulus presentation 81 and resulting action 89 (the reaction time) is denoted by r₀. It is noted that displays 70 may comprise any of head up displays (HUD), head mounted displays (HMD), down displays, near-to-eye (NTE) display, any type of display such as CRT (cathode ray tube), LCD (liquid crystal display), LED (light emitting diodes display) etc. as well as virtual displays such as augmented reality visors.

The timeline also presents a cueing paradigm 101 that comprises, according to some embodiments, presentation of a cue 110 to attract the user's attention prior to presentation of stimulus 81. For example, cue 110 may be presented at time c (e.g., 1 ms<c<300 ms) prior to stimulus 81. As a result, the user attends 115 stimulus 81 earlier than the user attends 85 stimulus 81 without cue 110, namely after a shorter period a<a₀. As a result, using cueing paradigm 101, the user's reaction time shortens from r₀ to r (measured from stimulus 81 to action 89), by Δt. The lower part of FIG. 1 demonstrates in a non-limiting manner simplified HUD 70 with constant data 80A (e.g., a horizon) and dynamic data 80B (e.g., an altitude, a velocity, an angle), and the presentation of visual cue 110 (e.g., a rectangle enclosing the position of the stimulus) prior to the presentation of stimulus 81 according to the timeline. It is noted that the cue precedence time c, i.e., the time in which cue 110 is visible before the appearance of the actual information (stimulus 81) may vary, e.g., between 10-500 ms, depending on various circumstances, such as the importance of the information, other data appearing in the region, prior cues and stimuli etc. It is further noted that a duration of cue 110 may be short or long (e.g., between 50 ms-1500 ms), and cue 110 may at least partially overlap stimulus 81 (denoted by the broken line). Cue duration may likewise depend on various circumstances, such as the importance of the information, other data appearing in the region, prior cues and stimuli etc. Cues 110 may comprise graphical elements such as frames that enclose stimulus 81, arrows pointing to the location of stimulus 81, flankers displayed at the edge of the display beyond the position of stimulus 81 but at the angle of stimulus 81 and any other graphical element which may attract the user's attention to stimulus 81.

It is noted that different cues and cue parameters may be associated with different types of data and with different information contents of the data. For example, certain cue shapes and/or colors may be associated with different data type, cues may be made more prominent on the display as the information they attract the user's attention to is more important, and so forth.

FIG. 2 illustrates schematically a timeline for multiple stimuli 81A, 81B, and resulting actions 89A, 89B according to prior art paradigm 90 (above timeline) and according to cueing paradigm 101. Cueing, using visual cues 110A, 110B, yield earlier attendance times 115A, 115B than prior art attendance times 85A, 85B, which may result in a cumulative shortening of the overall reaction time, Σr (in cueing paradigm 101)<Σr₀ (in prior art paradigm 90), in case consecutive stimuli 81B are presented earlier in cueing paradigm 101 than in prior art paradigm 90 due to the shortened response time of the user. For example, in the illustrated case, the reaction time to first stimulus 81A is shortened by Δt₁, and consecutive stimulus 81B is presented Δt₂ earlier than in the prior art, resulting in shortening the overall reaction time by Δt₁+Δt₂, allowing more information to be presented to the user within a given time period. It is noted that intervals c₁, c₂ of presenting cues 110A, 110B before stimuli 81A, 81B, respectively, may be modified and adapted to an overall stimuli presentation scheme.

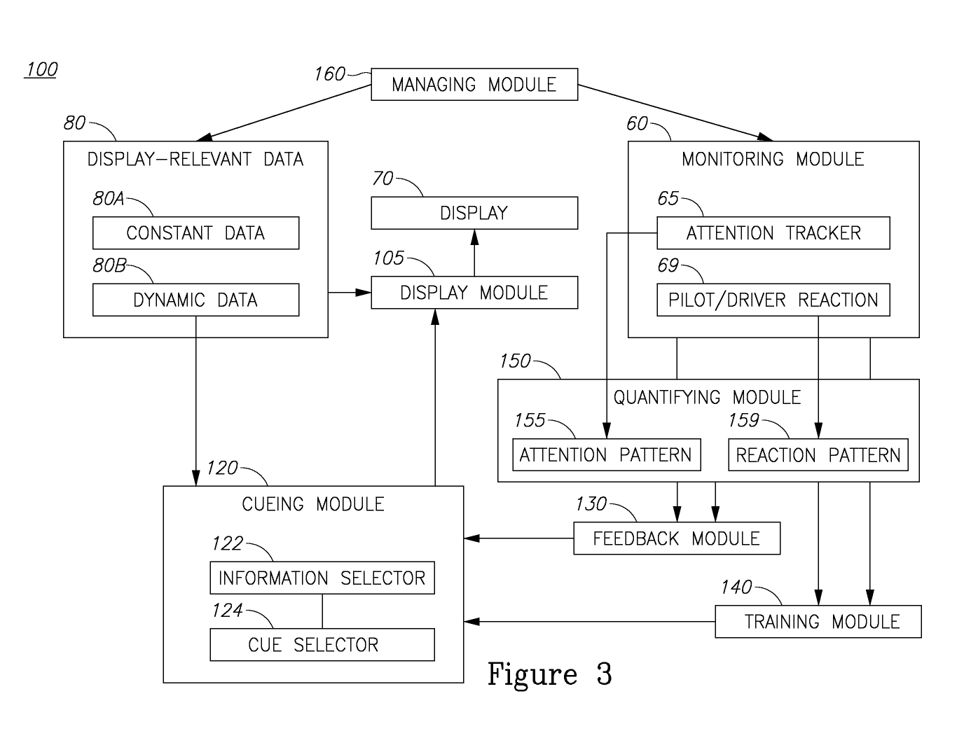

FIG. 3 is a high level schematic block diagram of a cueing system 100, according to some embodiments of the invention. System 100 comprises a cueing module 120 in communication with a display module 105 that operates a display 70. Cueing module 120 may be configured to identify, from display-relevant data 80, a piece of information (e.g., by an information selector 122), locate a display position of the identified piece of information, and instruct display module 105 to display visual cue 110 at a specified interval (e.g., between 10 and 500 ms) prior to displaying the piece of information, at a cue position on display 70 that has a specified spatial relation to the display position of the piece of information (e.g., at the same location or within an angular range corresponding to fovea size). System 100 may further comprise display module 105 and/or display 70 and implement any of cueing paradigms 101 described above. In certain embodiments, visual cue 110 may be selected (e.g., by a cue selector 124) according to visual parameters of display-relevant data 80 such as position on the display, font and size, color, etc. Visual cue 110 may be similar in one or more visual parameter to stimulus 81, may vary in one or more visual parameter to stimulus 81 and/or the level of similarity between Visual cue 110 and stimulus 81 may be adjusted according to various parameters, such as importance or urgency of stimulus 81, detected tendencies of the user to miss stimulus 81 (based on past experience), other currently displayed data etc.

Display-relevant data 80 may comprise constant data 80A and dynamic data 80B. Visual cues 110 mainly refer to the latter. Cueing module 120 may be configured to present a plurality of visual cues 110 according to a specified display scanning scheme, e.g., a typical pilot display scanning scheme.

In certain embodiments, cueing module 120 may be further configured to configure visual cues 110 according to urgency parameters of the piece of information.

Cueing module 120 may be configured to maintain a specified period between repetitions of visual cues 110 at a specified range of cue positions, to reduce the inhibition of return (IOR) phenomenon of slower reaction to cue repetitions at a same location. For example, within a certain predefined angular range (e.g., corresponding to one or several fovea sizes), repetitions of visual cues 110 may be limited to less than one per 1 sec. It is noted that IOR is typically about 200 ms, but may vary between users and vary significantly depending on different circumstances such as the region of the display, the user occupancy and general attention, and other factors. System 100 (e.g., via feedback module 130 and/or via training module 140, as explained below) may be configured to measure the user's IOR or evaluate the user's cue awareness in other ways, and adjust the cueing scheme accordingly. For example, cue durations, intervals between cues and cued stimuli may be adjusted accordingly.

In certain embodiments, system 100 may comprise a feedback module 130 in communication with cueing module 120 and with a monitoring module 60 that monitors a user of display 70. For example, monitoring module 60 may comprise a user attention tracker 65 (e.g., an eye tracker) configured to follow the tempo-spatial shifts of attention of the user, and/or a user reaction monitor 69 configured to follow user actions 89 with respect to stimuli 81. In certain embodiments, monitoring module 60 may comprise or employ any sensor or method to track users' attention and reactions. In one example, an inertial measurement unit (IMU) in a HMD may be used to monitor the user head movements to verify specified scanning patterns or the efficiency of specific attention drawing cues. In another example, monitoring module 60 may check for expected responses of the user (e.g., an audio commend that should result from a specific displayed piece of information) and report expected reactions or lack thereof.

Feedback module 130 may be configured to evaluate an efficiency of the cueing, and cueing module 120 may be further configured to modify one or more parameter of visual cues 110 according to the evaluated efficiency. For example, any parameter of visual cues 110 such as its timing (e.g., the specified period c before stimulus 81, the duration of cue 110, inter-cue periods etc.), its graphical features such as color, shape and size with respect to surroundings in display 70, the relative position of cue 110 with respect to stimulus 81, etc.

In certain embodiments, system 100 may comprise a training module 140 in communication with cueing module 120 and with monitoring module 60. Monitoring module 60 may be configured to identify a display scanning scheme of a user of display 70, and training module 140 may be configured to present multiple visual cues 110 to correct the user's display scanning scheme with respect to a specified required display scanning scheme. Training module 140 may be configured to provide any number of benefits, such as streamlining the user's use of the display, reducing the user's reaction times, improve reaction times to certain types of data or to unexpected data and generally improve the situational awareness of the user. Training module 140 may be personalized, with different settings for differently trained users, determined ahead of training and/or based on prior training data.

In certain embodiments, system 100 may comprise a quantifying module 150 configured to quantify an attention pattern 155 of a user with respect to the displayed data and visual cues. Attention pattern 155 may comprise a spatio-temporal relation of estimated locations of a user's attention to the displayed data and visual cues, as measured e.g., by attention tracker 65 such as an eye tracker or as received by the vehicle's host-system (that operates the display). Quantifying module 150 may be further configured to relate quantified attention pattern 155 to a user's reaction pattern 159 that includes recorded reaction times of the user to the displayed data (as measured e.g., by user reaction monitor 69, in form of the user's reaction to the cued information). The relations between attention pattern 155 and reaction pattern 159 may be used in various ways, for example by feedback module 130 to evaluate the effectiveness of different cues with respect to the user's reaction times, and/or by training module 140 that may be further configured to modify spatio-temporal parameters of the visual cues to decrease the user's reaction times according to specified requirements.

Any element of system 100, in particular feedback module 130 and/or training module 140, may be configured to process user specific data. For example, system 100 may comprise a user identification module (not shown) for processing data and adjusting cueing patterns to a user's past reaction database. The identification of the user may be carried out by any type of user input (e.g., by code or user name) or by automatic user identification according to the user's physiological parameters (e.g., weight on seat, eye scan etc.) as well as according to user reaction to displayed information, stimuli and cues (e.g., according to display scanning pattern). Feedback module 130 and/or training module 140 may be configured to associate specific cueing patterns and user reactions to specified users, and possibly also to identify users according to their display interaction patterns. In certain embodiments, feedback module 130 and/or training module 140 may be configured to provide user related cueing information for later analysis or to save user reaction patterns and times for future usage. In certain embodiments, user identification and/or user-related analysis capabilities may be at least partly incorporated into monitoring module 60.

System 100 may be configured to guide the user's attention to specific positions of the display and/or to specific events that require user response, e.g., according to predefined rules. System 100 may be configured to implement different cueing schemes. For example, different users may be prompted by different cueing schemes depending on their habits, scanning patterns and/or depending on the displayed information content. The cueing schemes may be adapted as user attentiveness changes, e.g., due to habituation, fatigue and/or training. Feedback module 130 may be configured to provide data required for adapting the cueing scheme. System 100 may further comprise a managing module 160 configured to manage cueing schemes for different users and with respect to data from feedback and training modules 130, 140. Alternatively or complementarily, managing module 160 may be configured to control the displayed data according to feedback data, e.g., increase or reduce the levels of cluster on the display and/or managing module 160 may be configured to control the monitoring of the user to monitor specific reactions of the user.

In certain embodiments, system 100 may be further configured to change data display parameters, update information and change displayed information with or without respect to the implemented cueing. For example, clutter may be reduced by attenuating less important data (e.g., by dimming the respective displayed data) or enhance more important data (e.g., by changing the size, brightness or color of respective displayed data or pieces of information), possibly according to specified criteria which relate to user identity, current situation, operational mode etc. Examples for operational modes, in the non-limiting context of a pilot, are various parts of flight and aircraft control patterns such as taking off, climbing, cruising, approaching an air field, descending, landing, movements on the ground, taxiing, etc. In each mode, different flight information is relevant—e.g., during takeoff only momentary velocity and height and general navigation aids are displayed, during approaches exact navigation aids are displayed, during landing on the runaway velocity and runaway-related data (e.g., available distance, expected stopping point), during taxiing atmospheric and navigation information may be presented and so forth. Operational modes may also comprise situation-related or mission-related modes, for example, malfunctions may be defined as operational modes that require displaying certain parameters, flight parameters may change between area reconnaissance and other flight missions as well as among various flight profiles (e.g., high and low altitudes, profiles related to different mission stages etc.).

In certain embodiments, stimuli 81 may be used as corresponding cues 110 and displayed prior to scheduled display timing of stimuli 81 or with same or different parameters than regularly presented.

In certain embodiments, system 100 may be configured to use audio cues 110 or alerts that relate to stimuli 81, in place or in addition to visual cues 110. In certain embodiments. The spatial apparent location of audio cues 110 may be related to the spatial location of corresponding stimulus 81 and/or to a type of information presented as stimulus 81, its priority, its importance according to specified criteria, etc.

In certain embodiments, system 100 may be integrated in control center software to enhance the usability of control center displays by users. System 100 may be configured to be applicable to any control station and to any display.

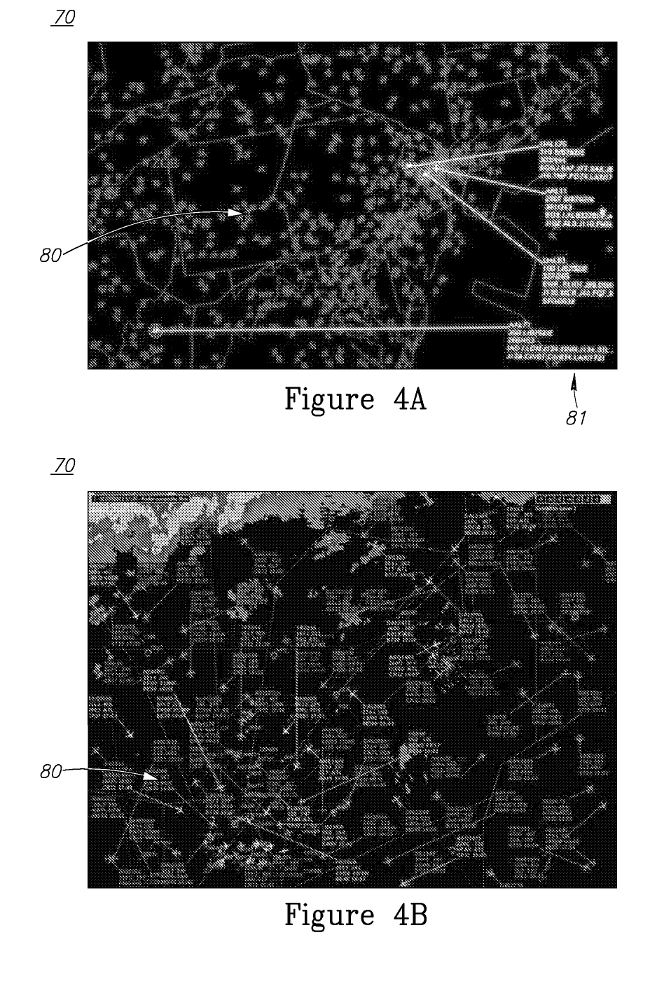

FIGS. 4A and 4B examples of clutter 80 in control center displays 70, according to some embodiments of the invention. FIG. 4A illustrates an area control center (ACC) depiction of air traffic during the September 11 attacks. Highlighted information 81 is identified as stimuli 81 that might have been enhanced over clutter 80 and might have contributed to the crisis prevention or management if users of displays 70 were made aware of it. FIG. 4B illustrates an ACC depiction of air traffic over the ocean. Clutter 80 in display 70 is characterized by many aircrafts, each associate with multiple displayed data items. Keeping an overview of such clutter 80 is very difficult, and system 100 may be used to highlight specific data which is determined by system 100 as being specifically relevant to a specific user at a specific control station (display 70) and/or at a specific situation or task. Alternatively or complementarily, system 100 may be configured to cue certain pieces of information to shorten the reaction time of the respective user thereto.

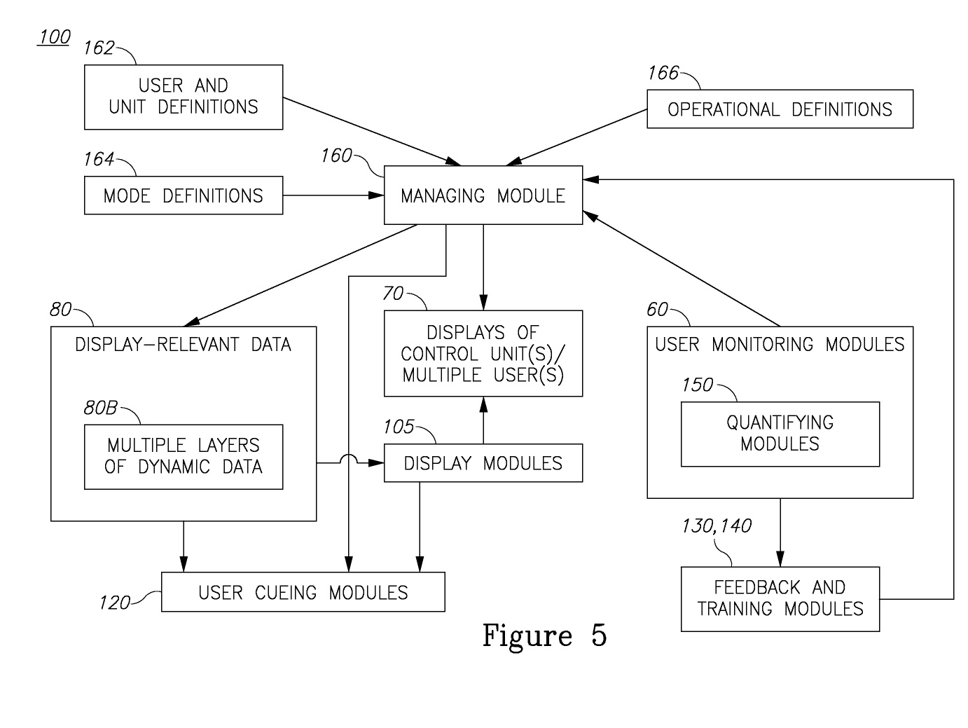

FIG. 5 is a high level schematic block diagram of system 100 for improving information flow through control centers, according to some embodiments of the invention. It is noted that the control centers may be of any kind, such as air control centers, unmanned aircraft control centers, traffic control centers, lookout control systems, border controls, rescue systems etc. In particular, system 100 may be implemented for managing displays of any station that provide users with multi-layered information may be displayed according to various types of users, various priorities, various operational context and any other criteria. Managing module 160 may be configured to receive user and unit definitions 162 (e.g., user priorities, ranks, permissions etc.), mode definitions 164 and/or operational definitions 166 (e.g., relating to specified missions) and adjust displayed information 80 on displays 70 accordingly. As exemplified above, managing module 160 may enhance or attenuate certain data items, determine configurations of displayed data, integrate data from different sources for presentation, monitor cueing schemes and their effect on user performance and event handling, monitor user reactions to displayed data (e.g., receiving data from user monitoring modules 60 and/or feedback and training modules 130, 140) and modify displaying parameters according to defined priorities and with respect to ongoing events. System 100 may be configured to adapt the displayed information according to user priorities, ranks, permissions etc. System 100 may be configured to test user alertness by monitoring specific pieces of information and monitoring user reactions thereto, e.g., in relation to specific requirements and/or in relation to specified mission(s) or process(es). System 100 may calibrate for each user the data display parameters (e.g., number of data items, density, separation between item) and the cueing schemes and use the calibration results as baseline for user evaluation. The calibration may be carried out at a preparatory stage or during the monitoring of the users.

As non-limiting examples, mode definitions 164 may relate to aircraft flight modes as exemplified above but in the context of the control center (e.g., relating to accident dangers or to temporal management of an airfield) and operational definitions 166 may relate to the missions performed by different aircrafts and missions handled by the control center itself, e.g., different types of aircrafts involved, reconnaissance and attack missions, missions related to different land or sea regions etc.

In certain embodiments, managing module 160 in control system 100 may be configured to select, from display-relevant data 80, a plurality of relevant data, the relevance thereof determined according to user definitions 162, mode definitions 164 and/or mission definitions 166, display the relevant data on respective one or more displays 70 of control system 100 and according to user definitions 162, monitor user reactions to the displayed relevant data, and enhance specific data from the relevant data on display(s) 70 which are selected according to the monitored user reactions with respect to user definitions 162, mode definitions 164 and/or mission definitions 166. The enhancing may comprise cueing piece(s) of information from the specific data—e.g., managing module 160 may be further configured to provide an auditory cue related to the cued piece of information with respect to a spatial position thereof on the respective display(s) and/or managing module 160 may be further configured to provide a visual cue associated with the cued piece of information. It is noted that in case of multi-layered information, cueing may be adjusted according to the respective layer of information to which the piece of information belongs (e.g., cues having different colors or different brightness levels may be used to cue stimuli belonging to different layers).

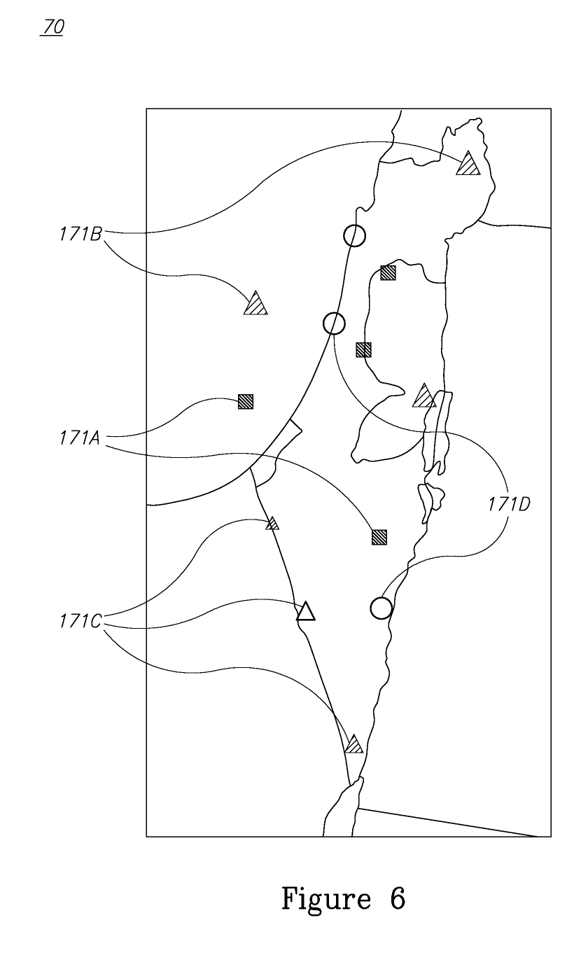

FIG. 6 is a high level schematic illustration of selection of displayed information, according to some embodiments of the invention. Displayed data on display 70 may comprise different types of information, relating to different contexts. In the illustrated example, the squares, circles and triangles represent aerial vehicles of different types 171A, 171D, 171B and different characters. A user at the control certain may need to address only certain types of aerial vehicles (e.g., ones represented by squares 171A), and the rest of the aerial vehicles may be removed from the user's display with no adverse effect to the control abilities of the user, and reducing the clutter on display improving the effectiveness of the control and reducing reaction times and fatigue. In another example, certain information relating to certain type(s) of aerial vehicles may be presented in more detail (see different triangles 171C) due to the reduction of clutter, improving the information content of display 70 and improving the control abilities of the user.

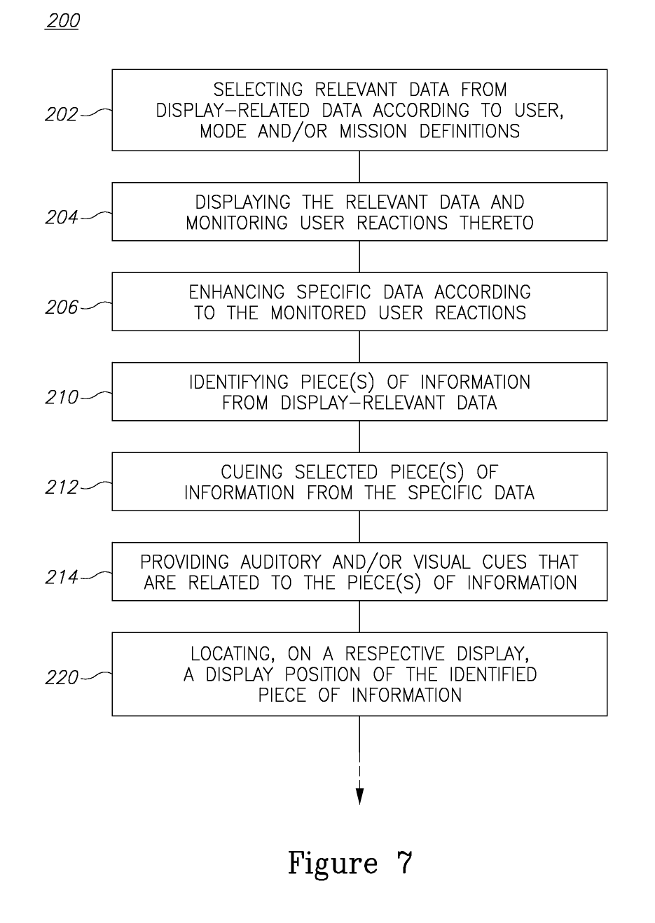

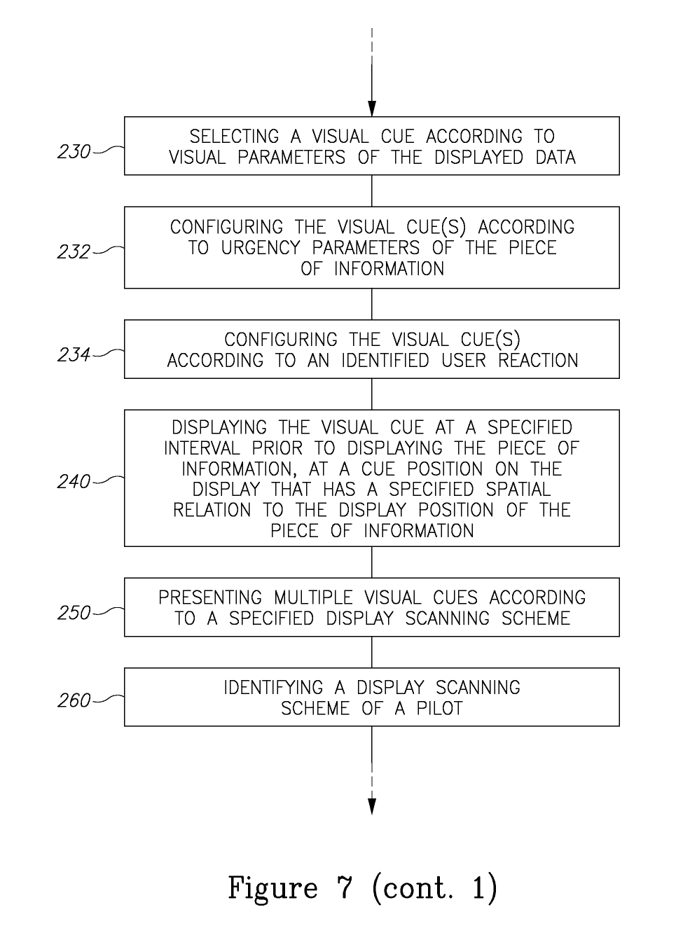

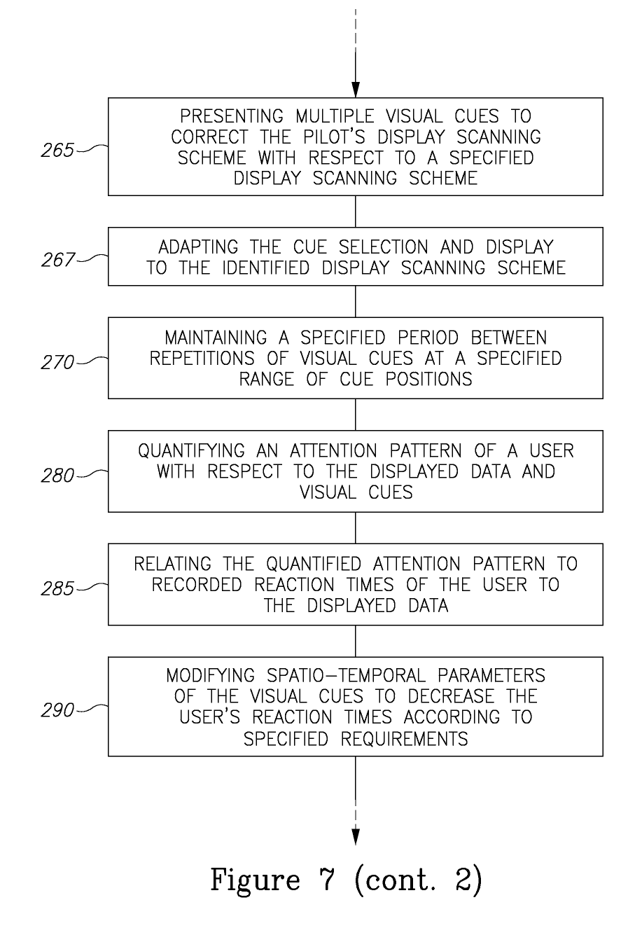

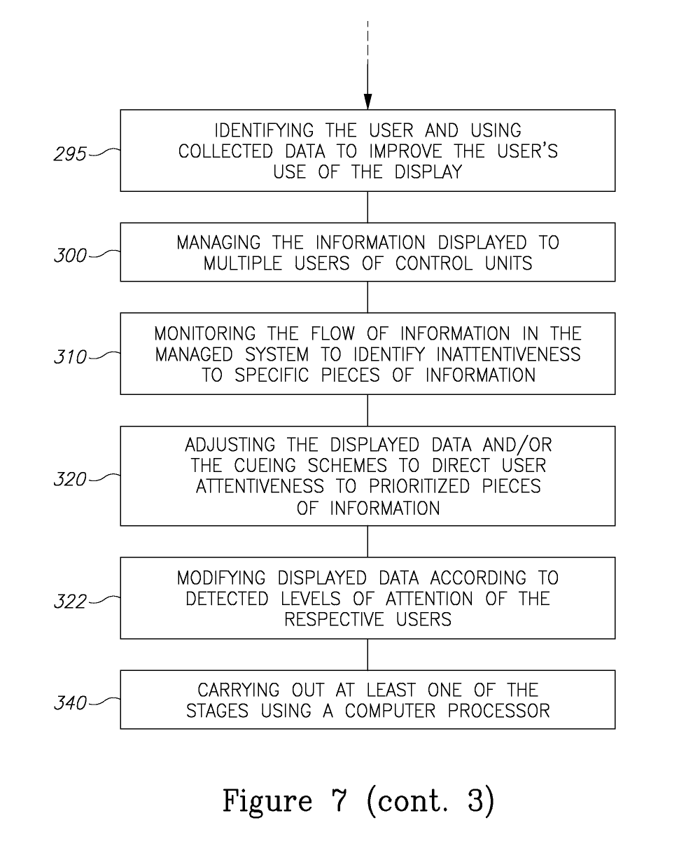

FIG. 7 is a high level schematic flowchart illustrating a method 200, according to some embodiments of the invention. Method 200 may be at least partially implemented by at least one computer processor. Certain embodiments comprise computer program products comprising a computer readable storage medium having computer readable program embodied therewith and configured to carry out the relevant stages of method 200.

Method 200 may comprise selecting, from display-relevant data, a plurality of relevant data, the relevance thereof determined according to at least one of user definitions, mode definitions and mission definitions (stage 202), displaying the relevant data and monitoring user reactions thereto (stage 204) and enhancing specific data from the relevant data, the enhanced data selected according to the monitored user reactions with respect to the at least one of user definitions, mode definitions and mission definitions (stage 206). Method 200 may further comprise cueing at least one piece of information from the specific data (stage 212), e.g., by providing auditory and/or visual cues that are related to the piece(s) of information (stage 214). For example, method 200 may provide an auditory cue related to the cued piece of information with respect to a spatial position thereof and/or with respect to a predefined relation of auditory cues and information types. In another example, method 200 may provide a visual cue associated with the cued piece of information, e.g., with respect to a spatial relation and/or visual parameter(s) thereof, possibly at a specified interval before displaying the cued piece of information.

In certain embodiments, method 200 may comprise identifying, from display-relevant data, a piece of information (stage 210), locating, on a respective display, a display position of the identified piece of information (stage 220), optionally selecting a visual cue according to visual parameters (e.g., location, color, size, font) of the display-relevant data (stage 230), and displaying the visual cue at a specified interval (e.g., between 10 and 500 ms) prior to displaying the piece of information, at a cue position on the display that has a specified spatial relation to the display position of the piece of information (stage 240).

As a non-limiting example, the display may be a pilot display and the display-relevant data and the identified piece of information may relate to an aircraft flown by the pilot. As another non-limiting example, the display may be a road vehicle display and the display-relevant data and the identified piece of information may relate to the vehicle driven by the user. In certain embodiments, method 200 may further comprise configuring the visual cue according to urgency parameters of the piece of information (stage 232). Method 200 may comprise configuring the visual cue(s) according to an identified user reaction (stage 234), e.g., from vehicle feedback, from a user monitoring unit etc.

In certain embodiments, method 200 may further comprise presenting a plurality of the visual cues according to a specified display scanning scheme (stage 250).

In certain embodiments, method 200 may further comprise identifying a display scanning scheme of the pilot (stage 260) and presenting a plurality of the visual cues to correct the pilot's display scanning scheme with respect to a specified display scanning scheme (stage 265). Method 200 may further comprise adapting cue selection 230 and display 240 to the identified display scanning scheme (stage 267).

In certain embodiments, method 200 may further comprise maintaining a specified period (of at least one second) between repetitions of the visual cue displaying at a specified range of cue positions (stage 270).

In certain embodiments, method 200 may further comprise quantifying an attention pattern of a user with respect to the displayed data and visual cues (stage 280), the attention pattern comprising a spatio-temporal relation of estimated locations of a user's attention to the displayed data and visual cues, relating the quantified attention pattern to recorded reaction times of the user to the displayed data (stage 285), and modifying spatio-temporal parameters of the visual cues to decrease the user's reaction times according to specified requirements (stage 290).

In certain embodiments, method 200 may comprise identifying the user and using collected data to improve the user's use of the display (stage 295). Any of the method aspects may be applicable to different users and different displays, e.g., to pilots using aircraft displays, drivers using vehicle displays, cellphone users and so forth. At least one of the stages of method 200 may be carried out at one of the stages using a computer processor (stage 340).

In certain embodiments, method 200 may comprise managing the information displayed to multiple users of control units (stage 300), e.g., control center users, monitoring the flow of information in the managed system to identify inattentiveness to specific pieces of information (stage 310) and adjusting the displayed data and/or the cueing schemes to direct user attentiveness to prioritized pieces of information (stage 320). In certain embodiments, method 200 may further comprise modifying displayed data according to detected levels of attention of the respective users (stage 322).

System 100 and method 200 may be used for training a user to scan the display more efficiently and to enable optimal utilization of the limited attention resources of the user. System 100 and method 200 may be used to manage multiple users that monitor multi-layered information on respective displays in control centers.

In the above description, an embodiment is an example or implementation of the invention. The various appearances of “one embodiment”, “an embodiment”, “certain embodiments” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone.

Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
identifying, from display-relevant data, a piece of information,
locating, on a respective display, a display position of the identified piece of information, and
displaying a visual cue at a specified interval prior to displaying the piece of information, at a cue position on the display that has a specified spatial relation to the display position of the piece of information.

2. The method of claim 1, further comprising selecting a visual cue according to visual parameters of the displayed data.

3. The method of claim 1, wherein the display is a vehicle display and wherein the displayed data and the identified piece of information relate to a vehicle driven by a driver.

4. The method of claim 1, wherein the display is a pilot display and wherein the displayed data and the identified piece of information relate to an aircraft flown by a pilot.

5. The method of claim 4, further comprising presenting a plurality of the visual cues according to a specified display scanning scheme.

6. The method of claim 4, further comprising identifying a display scanning scheme of the pilot and presenting a plurality of the visual cues to correct the pilot's display scanning scheme with respect to a specified display scanning scheme.

7. The method of claim 4, further comprising identifying a display scanning scheme of the pilot and adapting the cue selection and display to the identified display scanning scheme.

8. The method of claim 1, further comprising configuring the visual cue according to urgency parameters of the piece of information.

9. The method of claim 1, further comprising configuring the visual cue according to an identified user reaction.

10. The method of claim 1, wherein the specified interval is between 10 ms and 500 ms.

11. The method of claim 1, further comprising maintaining a period of at least one second between repetitions of the visual cue displaying at a specified range of cue positions.

12. The method of claim 1, further comprising:
quantifying an attention pattern of a user with respect to the displayed data and visual cues, the attention pattern comprising a spatio-temporal relation of estimated locations of a user's attention to the displayed data and visual cues,
relating the quantified attention pattern to recorded reaction times of the user to the displayed data, and
modifying spatio-temporal parameters of the visual cues to decrease the user's reaction times according to specified requirements.

13. A system comprising a cueing module in communication with a display module that operates a display, the cueing module configured to identify, from displayed data, a piece of information, locate a display position of the identified piece of information, select a visual cue according to visual parameters of the displayed data, and instruct the display module to display the visual cue at a specified interval prior to displaying the piece of information, at a cue position on the display that has a specified spatial relation to the display position of the piece of information.

14. The system of claim 13, further comprising the display module and the display.

15. The system of claim 13, wherein the cueing module is further configured to present a plurality of the visual cues according to a specified display scanning scheme.

16. The system of claim 13, wherein the cueing module is further configured to configure the visual cue according to urgency parameters of the piece of information.

17. The system of claim 13, wherein the specified interval is between 0 and 500 ms.

18. The system of claim 13, wherein the cueing module is further configured to maintain a specified period between repetitions of the visual cue at a specified range of cue positions.

19. The system of claim 13, further comprising a feedback module in communication with the cueing module and with a monitoring module that monitors a user of the display, the feedback module configured to evaluate an efficiency of the cueing, wherein the cueing module is further configured to modify at least one parameter of the visual cue according to the evaluated efficiency.

20. The system of claim 13, further comprising a training module in communication with the cueing module and with a monitoring module that is configured to identify a display scanning scheme of a user of the display, the training module configured to present a plurality of the visual cues to correct the user's display scanning scheme with respect to a specified display scanning scheme.

21-30. (canceled)
